(19) United States
(12) Patent Application Publication
(10) Pub. No.: US 2024/0337435 A1
(43) Pub. Date: Oct. 10, 2024

(54) REFRIGERATOR

(71) Applicant: SAMSUNG ELECTRONICS CO., LTD., Suwon-si Gyeonggi-do (KR)

(72) Inventors: Inyong HWANG, Suwon-si (KR); Jonghoon OH, Suwon-si (KR); Hyungbum LEE, Suwon-si (KR)

(73) Assignee: SAMSUNG ELECTRONICS CO., LTD., Suwon-si Gyeonggi-do (KR)

(21) Appl. No.: 18/746,985

(22) Filed: Jun. 18, 2024

Related U.S. Application Data
(63) Continuation of application No. PCT/KR2022/017413, filed on Nov. 8, 2022.

(30) Foreign Application Priority Data
Jan. 4, 2022 (KR) 10-2022-0001209

(51) Int. Cl. F25D 27/00; F21V 7/00; F21V 23/00; F21W 131/305; F25D 23/06

(52) U.S. Cl. CPC F25D 27/00; F21V 7/0008; F21V 23/001; F25D 23/065; F21W 2131/305

(57) ABSTRACT

A refrigerator including an inner case forming a storage compartment and including a lamp receiving portion having a receiving space recessed, an outer case coupled to an outer side of the inner case, a lamp, arrangeable in the receiving space of the inner case, and including a light source that emits light, and a cover coupleable to the inner case so as to cover the receiving space. The lamp receiving portion includes a reflective surface at a position facing the light source to reflect light emitted from the light source of the lamp, which is arranged in the receiving space, toward the storage compartment side.

### CROSS-REFERENCE TO RELATED APPLICATION

This application is a continuation application, under 35 U.S.C. § 111 (a), of international application No. PCT/KR2022/017413, filed Nov. 8, 2022, which claims priority under 35 U. S. C. § 119 to Korean Patent Application No. 10-2022-0001209, filed Jan. 4, 2022, the disclosures of which are incorporated herein by reference in their entireties.

### BACKGROUND

### Field

The disclosure relates to refrigerators, and more particularly, to a refrigerator including a lighting device.

### Description of the Related Art

In general, a refrigerator, an appliance for keeping food fresh, includes a storage compartment for storing food and a cold air supply device for supplying cold air to the storage compartment.

A refrigerator has a door for opening and closing the storage compartment to seal the interior of the storage compartment and to prevent cold air from leaking out, thereby maintaining the storage compartment at a low temperature.

When a user puts in or takes out of food from the storage compartment, the storage compartment is dark due to lack of light from the outside, and thus a separate lighting device is installed to illuminate the interior of the storage compartment.

Such a lighting device is turned on upon opening of the door by a user to access food in the storage compartment, thereby illuminating the interior of the storage compartment.

### SUMMARY

According to an embodiment of the present disclosure, a refrigerator includes an inner case forming a storage compartment and including a lamp receiving portion having a receiving space that is recessed, an outer case coupleable to an outer side of the inner case, a lamp, arrangeable in the receiving space of the inner case, and including a light source that emits light, and a cover coupleable to the inner case so as to cover the receiving space, wherein the lamp receiving portion includes a reflective surface at a position facing the light source to reflect light emitted from the light source of the lamp, which is arranged in the receiving space, toward the storage compartment side.

The reflective surface may be inclined.

The reflective surface may be inclined downwardly toward the cover as a distance from the light source increases.

The refrigerator may further include an insulation foamed between the outer case and the inner case, wherein an outer surface of the lamp receiving portion facing the outer case may be in contact with the insulation.

An inner surface opposite to the outer surface of the lamp receiving portion may form the receiving space and includes the reflective surface.

The lamp receiving portion may include an opening through which an electric wire that is connectable to the lamp is led to the outside of the inner case so as to supply power to the lamp.

The refrigerator may further include a wire housing, coupleable to the opening of the lamp receiving portion, and including a through hole through which the electric wire passes to allow the electric wire to be led to the outside of the lamp receiving portion.

The through hole of the wire housing may be arrangeable along a direction corresponding to one side of the lamp connected to the electric wire.

The cover may include a wire guide portion to guide the electric wire, which is connected to the lamp, to the through hole of the wire housing and protrude from a bottom to secure the electric wire.

An inner surface of the lamp receiving portion facing the lamp may include a coupling groove to which the cover is coupled.

The cover may include a lamp mounting portion protruding from a bottom to support the lamp.

The cover may include a cover frame forming a perimeter and a light emitting plate transmitting light emitted from the lamp into the storage compartment, and the lamp mounting portion may be arrangeable on the cover frame.

The reflective surface may be inclined with the light emitting plate so as to reflect light emitted from the light source to the light emitting plate of the cover.

The light emitting plate may be formed of a translucent material.

According to an embodiment of the present disclosure, a refrigerator includes an outer case forming an exterior thereof, an inner case arranageable within the outer case to form a storage compartment, the inner case including a lamp receiving portion formed to be recessed to accommodate a lamp, and an insulation arranageable between the outer case and the inner case, wherein an inner surface of the lamp receiving portion facing the lamp includes a reflective surface configured to reflect light emitted from the lamp, which is arranged in the lamp receiving portion, toward the storage compartment side, and an outer surface of the lamp receiving portion is in contact with the insulation.

The refrigerator may further include a cover closing the lamp receiving portion and supporting the lamp, wherein the lamp receiving portion may include a coupling groove allowing the cover to be coupled.

The cover may be coupled by contacting the lamp receiving portion of the inner case.

The lamp receiving portion may be disposed on an upper surface of the storage compartment, and the reflective surface may be disposed on a rear side of the lamp.

The lamp receiving portion may include an opening disposed on an upper portion of the lamp receiving portion so that an electric wire connected to the lamp is led to the outside of the inner case.

The reflective surface may be configured to be inclined downwardly toward the upper surface of the storage compartment as the reflective surface approaches a rear side of the storage compartment.

### BRIEF DESCRIPTION OF DRAWINGS

FIG. 1 is a perspective view illustrating a refrigerator according to an embodiment of the present disclosure.

FIG. 2 is a schematic side cross-sectional view of the refrigerator shown in FIG. 1 according to an embodiment of the present disclosure.

FIG. 3 is an exploded view illustrating a configuration of a lighting assembly of the refrigerator shown in FIG. 1 according to an embodiment of the present disclosure.

FIG. 4 is an exploded view of the lighting assembly of FIG. 3 assembled and viewed from above according to an embodiment of the present disclosure.

FIG. 5 is a view of the lighting assembly of FIG. 3 assembled and viewed from below according to an embodiment of the present disclosure.

FIG. 6 is an enlarged view of an outer surface of the lamp receiving portion of the lighting assembly of FIG. 3 according to an embodiment of the present disclosure.

FIG. 7 is an enlarged view of an inner surface of the lamp receiving portion of the lighting assembly of FIG. 3 according to an embodiment of the present disclosure.

FIG. 8 is a view illustrating a wire housing of the lighting assembly of FIG. 3 coupled to the lamp receiving portion according to an embodiment of the present disclosure.

FIG. 9 is an enlarged view of the wire housing of the lighting assembly of FIG. 3, viewed from above according to an embodiment of the present disclosure.

FIG. 10 is an enlarged view of the wire housing of the lighting assembly of FIG. 3, viewed from below according to an embodiment of the present disclosure.

FIG. 11 is a perspective view of an inner surface of a cover of the lighting assembly of FIG. 3 according to an embodiment of the present disclosure.

FIG. 12 is a view illustrating a lamp mounted on the cover of FIG. 11 according to an embodiment of the present disclosure.

FIG. 13 is a cross-sectional view of the lighting assembly of FIG. 3 according to an embodiment of the present disclosure.

FIG. 14 is a view illustrating the lighting assembly of FIG. 13 being illuminated according to an embodiment of the present disclosure.

### DETAILED DESCRIPTION

Various embodiments of the present document and terms used therein are not intended to limit the technical features described in this document to specific embodiments, and should be understood to include various modifications, equivalents, or substitutes of the corresponding embodiments.

In addition, the same reference numerals or signs shown in the drawings of the disclosure indicate elements or components performing substantially the same function.

Also, the terms used herein are used to describe the embodiments and are not intended to limit and/or restrict the disclosure. The singular forms “a,” “an” and “the” are intended to include the plural forms as well, unless the context clearly indicates otherwise. In this disclosure, the terms “including”, “having”, and the like are used to specify features, figures, steps, operations, elements, components, or combinations thereof, but do not preclude the presence or addition of one or more of the features, figures, steps, operations, elements, components, or combinations thereof.

It will be understood that, although the terms “first”, “second”, “primary”, “secondary”, etc., may be used herein to describe various elements, but elements are not limited by these terms. These terms are only used to distinguish one element from another element. For example, without departing from the scope of the disclosure, a first element may be termed as a second element, and a second element may be termed as a first element. The term of “and/or” includes a plurality of combinations of relevant items or any one item among a plurality of relevant items.

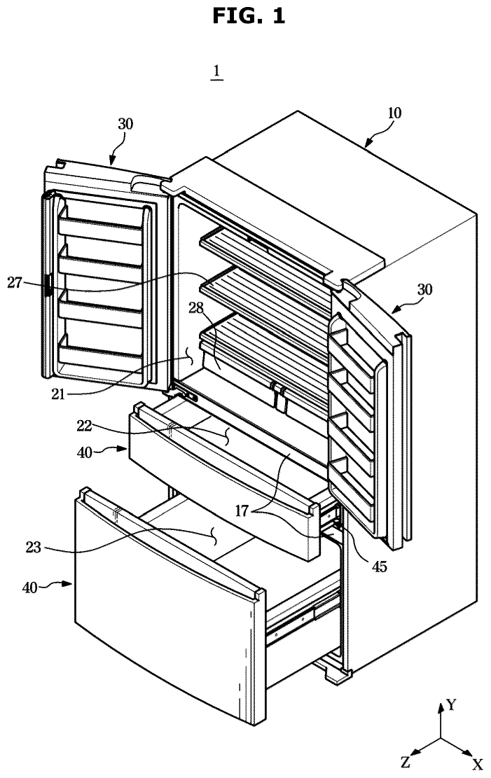

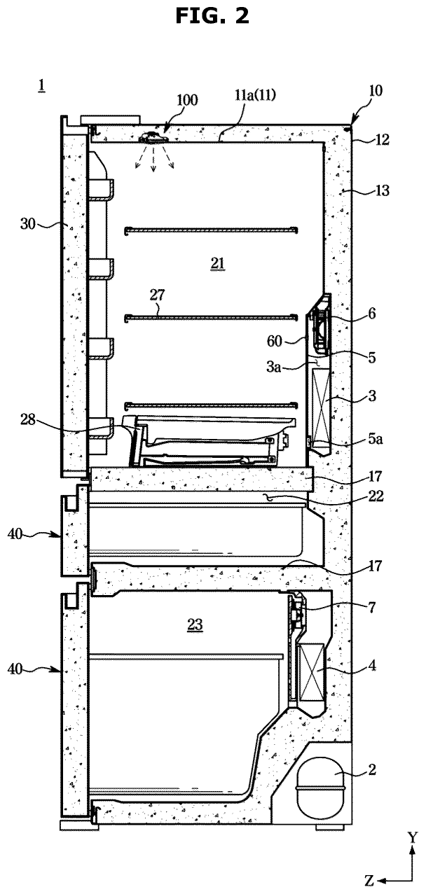

The directions of front, rear, top, bottom, left, and right will be referred to uniformly throughout the specification with reference to the directions shown in the accompanying drawings, such as, FIGS. 1 and 2. In FIGS. 1 and 2, an X-axis, a Y-axis, and a Z-axis direction perpendicular to each other are shown, wherein the X-axis direction may refer to a left-to-right direction of the refrigerator, the Y-axis direction may refer to an up-and-down direction of the refrigerator, and the Z-axis direction may refer to a front-to-back direction of the refrigerator.

The present disclosure is directed to a refrigerator having a lighting assembly with an improved structure to simplify the manufacturing process and reduce parts.

Further, the present disclosure is directed to a refrigerator having a lighting assembly in which light emitted from a lamp is not directly transmitted to the eyes of a user, thereby preventing glare.

According to various embodiments of the present disclosure, the lighting assembly may simplify the manufacturing process of the refrigerator and reduce parts by integrally forming the lamp receiving portion in which the lamp is disposed with the inner case.

Further, according to various embodiments of the present disclosure, when the lighting assembly illuminates the storage compartment, indirect lighting may be used to prevent glare to the user and to uniformly illuminate the interior of the storage compartment.

Hereinafter, various embodiments according to the disclosure will be described in detail with reference to the accompanying drawings.

FIG. 1 is a perspective view showing a refrigerator according to an embodiment of the present disclosure. FIG. 2 is a schematic side cross-sectional view of the refrigerator shown in FIG. 1.

The refrigerator 1 may include a main body 10 having storage compartments 21, 22, and 23, doors 30 and 40 provided to open or close the storage compartments 21, 22, and 23, and a cold air supply device provided to supply cold air to the storage compartments 21, 22, and 23.

The main body 10 may include an inner case 11 forming the storage compartments 21, 22, and 23, an outer case 12 coupled to an outer side of the inner case 11, and an insulation 13 provided between the inner case 11 and the outer case 12. The inner case 11 may be formed of a plastic material, and the outer case 12 may be formed of a metallic material.

The insulation 13 may be formed by injecting a molten resin into a space between the outer case 12 and the inner case 11 and then curing the injected molten resin. Urethane foam insulation may be used as the insulation 13 and, if desired, a vacuum insulation panel may be used together. The insulation 13 may be foamed between the inner case 11 and the outer case 12, thereby joining the inner case 11 and the outer case 12. An outer surface 11a of the inner case 11 may be in contact with the insulation 13.

The main body 10 may include partitions 17 that divide the storage compartments 21, 22, and 23 in a vertical direction.

The storage compartments 21, 22, and 23 may be used as a refrigerating room for keeping food refrigerated by being maintained at about 0 to 5 degrees Celsius, and a freezing room for keeping food frozen by being maintained at about −30 to 0 degrees Celsius.

The respective storage compartments 21, 22, and 23 may have an open front to allow food to be placed in and taken out, and the open front of the storage compartments 21, 22, and 23 may be opened and closed by the doors 30 and 40. The storage compartments 21, 22, and 23 may be provided with shelves 27 on which food may be placed and storage containers 28 on which food may be stored.

The cold air supply device may generate cold air using the latent heat of evaporation of a refrigerant through a cooling cycle. The cold air supply device may include a compressor 2, a condenser, an expansion device, evaporators 3 and 4, and blowing fans 6 and 7.

The first evaporator 3 may be disposed on a rear side of the first storage compartment 21 to generate cold air. The first evaporator 3 may be accommodated in a cooling chamber 3a formed by an evaporator cover 5. The evaporator cover 5 may include an inlet 5a formed therein, and air may be drawn in from the first storage chamber 21 into the cooling chamber 3a through the inlet 5a.

The cooling chamber 3a may be provided with a first blowing fan 6 to flow air. The cooling chamber 3a may be provided with a cooling outlet 60 for discharging cold air from the cooling chamber 3a into the interior of the first storage chamber 21. According to such a configuration, when the blowing fan 6 is operated, air may be drawn in from the first storage chamber 21 into the cooling chamber 3a via the inlet 5a, and the drawn-in air may be cooled through the evaporator 3 and then discharged into the interior of the first storage chamber 21 via the cooling outlet 60.

Referring to FIG. 2, the refrigerator 1 may include a lighting assembly 100. The lighting assembly 100 may provide light into the storage compartments 21, 22, and 23. In the drawings, the lighting assembly 100 is shown as an example of emitting light into the first storage compartment 21. The lighting assembly 100 may be installed on one side of the first storage compartment 21. In the drawings, the lighting assembly 100 is shown as an example of being installed on an upper surface of the first storage compartment 21, but the present disclosure is not limited thereto. The lighting assembly 100 may be installed on both side surfaces and/or on a lower surface of the first storage compartment 21, and may be provided in a plurality.

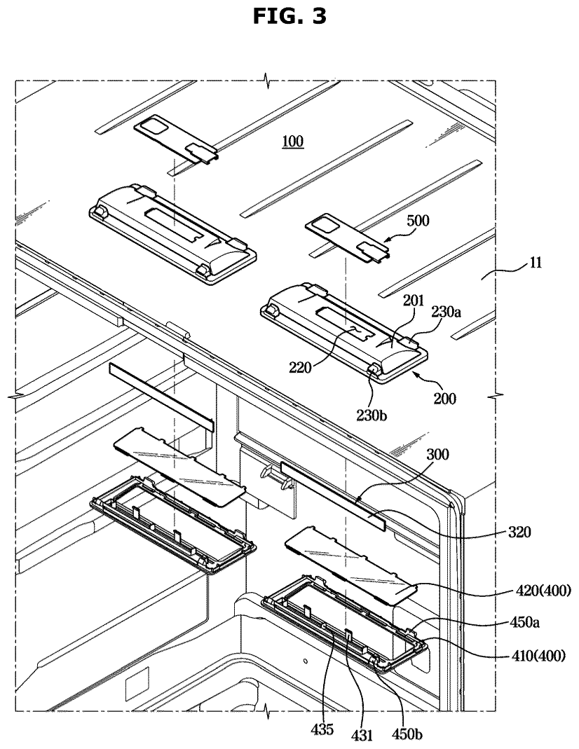

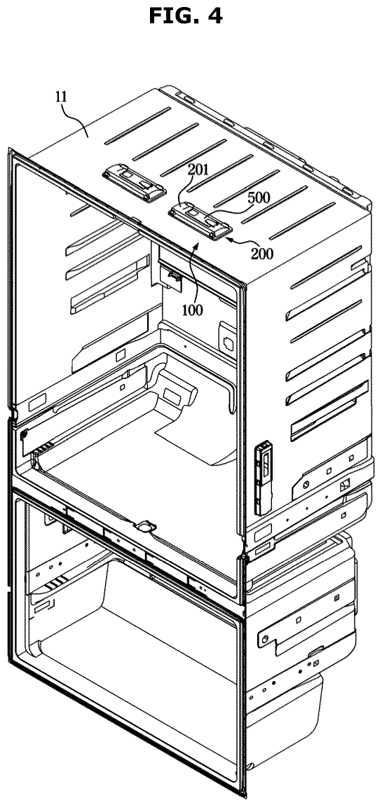

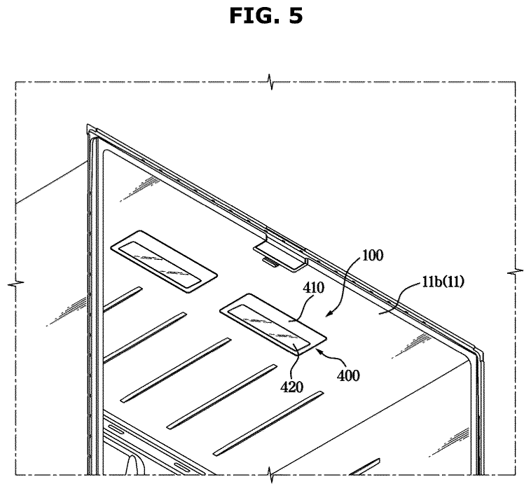

FIG. 3 is an exploded view showing a configuration of the lighting assembly of the refrigerator of FIG. 1. FIG. 4 is a view showing the lighting assembly of FIG. 3 assembled and viewed from above. FIG. 5 is a view showing the lighting assembly of FIG. 3 assembled and viewed from below.

The lighting assembly 100 may include a lamp receiving portion 200 in the inner case 11, a lamp 300, a cover 400, and a wire housing 500.

Referring to FIG. 3, the inner case 11 may include the lamp receiving portion 200. The lamp receiving portion 200 may include a wire housing opening 220, and the wire housing 500 may be coupled to the wire housing opening 220. The lamp 300 may be accommodated in the lamp receiving portion 200, and the cover 400 may be coupled to a lower portion of the lamp receiving portion 200.

After the wire housing 500 is coupled to the lamp receiving portion 200, a molten resin may be injected between the inner case 11 and the outer case 12 to form the insulation 13. In other words, the insulation 13 may be provided on an outer surface of the lamp receiving portion 200 and the wire housing 500.

When the lighting assembly 100 is assembled, the configuration thereof is as shown in FIGS. 4 and 5.

Referring to FIG. 4, the wire housing 500 may be coupled to the inner case 11. That is, the wire housing 500 may be coupled to the wire housing opening 220 of the lamp receiving portion 200 to prevent the molten resin for forming the insulation 13 from leaking into the lamp receiving portion 200 through the wire housing opening 220 of the lamp receiving portion 200.

The wire housing 500 may include a through hole through which an electric wire may pass. The through hole may allow the electric wire (not shown) to be inserted into the lamp receiving portion 200 of the inner case 11 and the electric wire to be connected to the lamp 300. Further details thereof will be described later.

Referring to FIG. 5, the cover 400 may be coupled to an inner surface 11b of the inner case 11. The lamp 300 may be accommodated in the lamp receiving portion 200, and the cover 400 may support the lamp 300.

The cover 400 may close one side of a receiving space 210 of the lamp receiving portion 200, thereby preventing the receiving space 210 from being exposed to the outside via the storage compartment 21. The cover 400 may prevent the lamp 300 disposed in the receiving space 210 from being exposed to the outside. In other words, only the cover 400 of the lighting assembly 100 may be exposed to the interior of the storage compartment 21 and the remaining components may be covered by the cover 400, thereby improving the aesthetics of the lighting assembly 100 that emits light into the storage compartment 21.

The cover 400 may include a cover frame 410 and a light emitting plate 420. The cover frame 410 may be formed of an opaque material, and the light emitting plate 420 may be formed of a light transmissive material. As a result, when the lamp 300 arranged inside the lamp receiving portion 200 emits light, the light may be emitted into the storage compartment 21 through the light emitting plate 420.

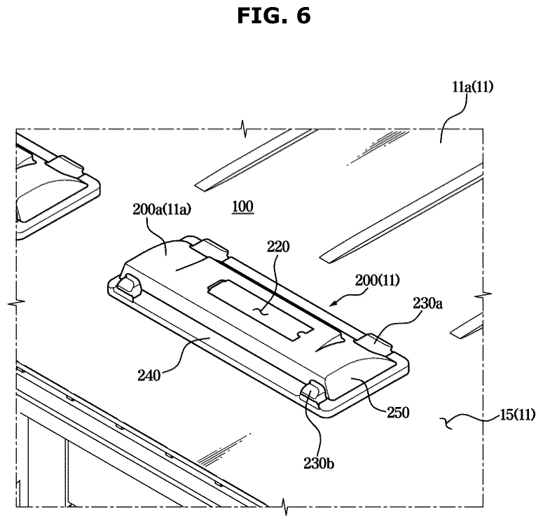

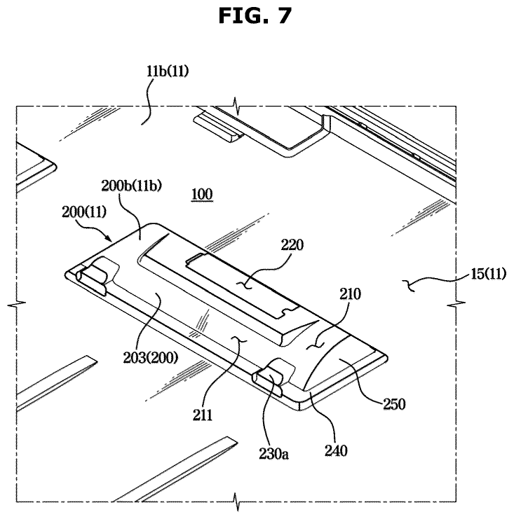

FIG. 6 is an enlarged view of an outer surface of the lamp receiving portion of the inner case. FIG. 7 is an enlarged view of an inner surface of the lamp receiving portion of the inner case.

The inner case 11 may include a plate portion 15. The plate portion 15 may be in the shape of a flat elongate plate.

The inner case 11 may include the lamp receiving portion 200. The lamp receiving portion 200 may be formed to be recessed in the inner case 11. The lamp receiving portion 200 may be arranged to protrude toward the outer case 12 coupled to the outer side of the inner case 11. The lamp receiving portion 200 may be provided in a convex round shape. The lamp receiving portion 200 may include the receiving space 210 in which the lamp 300 may be accommodated.

The lamp receiving portion 200 may extend from the plate portion 15. The lamp receiving portion 200 may be integrally formed with the plate portion 15. The lamp receiving portion 200 may be arranged to be recessed from the plate portion 15.

The inner case 11 may be formed by a vacuum forming process. Forming the inner case 11 may include forming the lamp receiving portion 200 by a vacuum forming process. The lamp receiving portion 200 may be formed integrally with the plate portion 15 of the inner case 11 through a vacuum forming process. In other words, in the process of manufacturing the inner case 11 by a vacuum forming process, the lamp receiving portion 200 may be simultaneously formed on one surface of the inner case 11.

Referring to FIG. 6, the lamp receiving portion 200 may include a lamp-receiving outer surface 200a. The lamp-receiving outer surface 200a may be arranged on the outer surface 11a of the inner case 11. The lamp-receiving outer surface 200a may protrude toward the outside of the inner case 11. The lamp-receiving outer surface 200a may be in contact with the insulation 13.

The lamp receiving portion 200 may include a perimeter portion 240 and a recessed portion 250. The perimeter portion 240 and the recessed portion 250 may be formed integrally. The recessed portion 250 may be formed extending from the perimeter portion 240.

The perimeter portion 240 may form a perimeter of the lamp receiving portion 200. The perimeter portion 240 may surround the recessed portion 250. The perimeter portion 240 may be connected to the plate portion 15 of the inner case 11. The perimeter portion 240 may protrude and extend from the plate portion 15 of the inner case 11 toward the outer side of the inner case 11.

The recessed portion 250 may be arranged on an inner side of the perimeter portion 240. The recessed portion 250 may protrude from the perimeter portion 240 toward the outer side of the inner case 11. The recessed portion 250 may be arranged by bending upwardly from the perimeter portion 240.

The lamp receiving portion 200 may include an opening. The opening may allow wires (not shown) to pass through the opening. In particular, the opening may include the wire housing opening 220. The wire housing opening 220 may penetrate the outer surface of the lamp-receiving outer surface 200a and an lamp-receiving inner surface 200b. The wires may be introduced into the inner case 11 through the wire housing opening 220. The lamp 300 accommodated in the lamp receiving portion 200 may be connected to the wires through the wire housing opening 220.

The wire housing opening 220 may correspond to the size and shape of the wire housing 500. However, the wire housing opening 220 may be smaller than the wire housing 500. In other words, the wire housing 500 may be formed larger than the wire housing opening 220.

The wire housing 500 may be coupled to the wire housing opening 220. In the drawings, the wire housing opening 220 is shown as an example formed on an upper surface of the lamp receiving portion 200, but the present disclosure is not limited thereto. For example, the wire housing opening 220 may be formed on a side surface of the lamp receiving portion 200. The wire housing opening 220 may penetrate the outer surface 200a and the inner surface 200b of the lamp receiving portion.

Referring to FIG. 7, the lamp receiving portion 200 may include the lamp-receiving inner surface 200b. The lamp-receiving inner surface 200b may be arranged on the inner surface 11b of the inner case 11. The lamp-receiving inner surface 200b may be recessed toward the outer side of the inner case 11. The lamp-receiving inner surface 200b may form the receiving space 210.

The lamp receiving portion 200 may include the receiving space 210. The receiving space 210 may be formed by an inner surface of the perimeter portion 240 and an inner surface of the recessed portion 250. The lamp 300 or the like may be accommodated in the receiving space 210. The receiving space 210 may be closed by the cover 400.

The lamp receiving portion 200 may include a cover opening 211. The cover opening 211 may correspond to the size and shape of the cover 400. However, the cover opening 211 may be smaller than the cover 400. In other words, the cover 400 may be formed larger than the cover opening 211.

The cover 400 may be coupled to the cover opening 211. In particular, the cover frame 410 of the cover 400 may be coupled around the perimeter of the cover opening 211. The cover opening 211 may be provided in a lower portion of the lamp receiving portion 200.

The lamp receiving portion 200 may include coupling grooves 230a and 230b. The cover 400 may be inserted into the coupling grooves 230a and 230b to be coupled to the inner case 11. The coupling grooves 230a and 230b may be arranged on the lamp-receiving inner surface 200b. In other words, since the coupling grooves 230a and 230b are arranged on the inner case 11 itself, the cover 400 may be coupled to the inner case 11 by directly contacting the inner case 11. The coupling grooves 230a and 230b may include a locking protrusion shape. The coupling grooves 230a and 230b may be provided in a plurality.

The lamp receiving portion 200 may include a reflective surface 203. The lamp-receiving inner surface 200b may include the reflective surface 203. The reflective surface 203 may reflect the light emitted from the lamp 300 and guide the reflected light toward the interior of the storage compartment. Further details thereof will be described later.

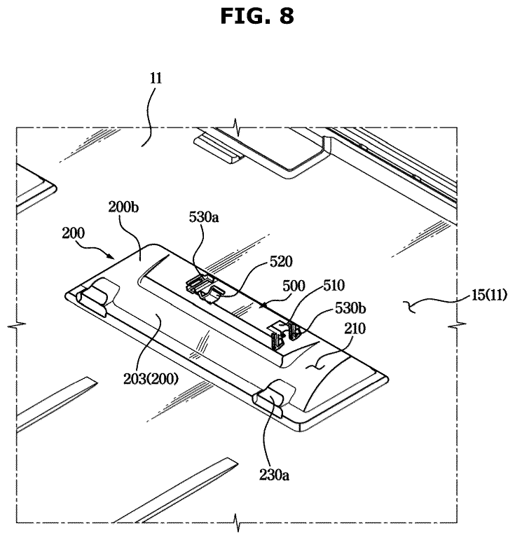

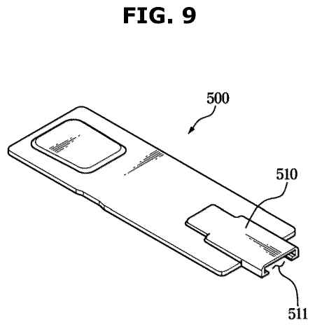

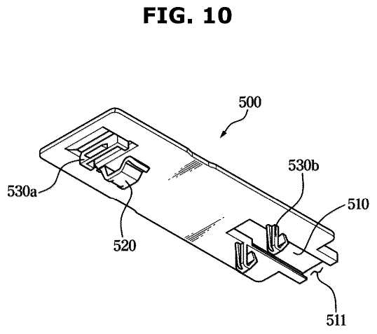

FIG. 8 is a view showing the wire housing coupled to the lamp receiving portion. FIG. 9 is an enlarged view of the wire housing from above and FIG. 10 is an enlarged view of the wire housing from below.

In a state where the wire housing 500 is coupled to the lamp receiving portion 200, an outer surface of the wire housing 500 may be connected to the lamp-receiving outer surface 200a and an inner surface of the wire housing 500 may be connected to the lamp-receiving inner surface 200b. The outer surface of the wire housing 500 may be in contact with the insulation 13, and the inner surface of the wire housing 500 may form the receiving space 210 of the lamp receiving portion 200.

The wire housing 500 may include a wire penetrating portion 510 through which wires pass. Referring to FIGS. 9 and 10, the wire penetrating portion 510 may include a wire through hole 511. A wire outside of the inner case 11 may pass through the wire through hole 511 and be inserted into the inner case 11. The wire inserted through the wire through hole 511 may be connected to the lamp 300 in the receiving space 210 and may supply power to the lamp 300. The wire through hole 511 may be arranged on one side of the wire housing 500.

The wire housing 500 may include a wire fixing portion 520. The wire fixing portion 520 may be arranged on the inner surface of the wire housing 500 to secure the wire inserted through the wire through hole 511 to the inner surface of the wire housing 500. The wire fixing portion 520 may serve to hang the wire on an inner surface of the wire housing 500 before the lamp 300 is installed in the lamp receiving portion 200 and the wire is connected to the lamp 300.

The wire housing 500 may include wire housing coupling protrusions 530a and 530b. The wire housing coupling protrusions 530a and 530b may be arranged on the inner surface of the wire housing 500. The wire housing coupling protrusions 530a and 530b may be arranged such that the wire housing 500 is coupled to the lamp receiving portion 200 through the wire housing opening 220. The wire housing coupling protrusions 530a and 530b may be arranged to penetrate the wire housing opening 220 and be locked to the inner surface of the lamp receiving portion 200b. The wire housing coupling protrusions 530a and 530b may be provided in a plurality.

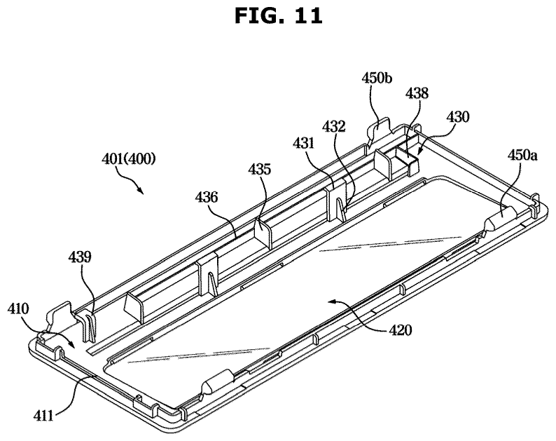

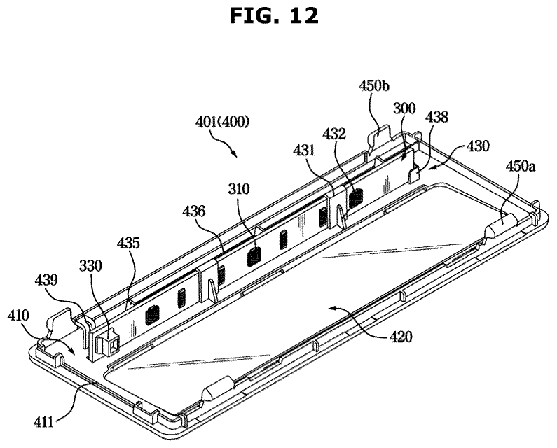

FIG. 11 is a view showing an inner surface of the cover 400, and FIG. 12 is a view showing the lamp 300 mounted on the cover 400.

The cover 400 may include a cover inner surface 401 and a cover outer surface 402. When the cover 400 is coupled to the lamp receiving portion 200, the cover outer surface 402 may be connected to the inner surface of the storage compartment, and the cover inner surface 401 may form the receiving space 210 of the lamp receiving portion 200. In other words, the outer surface of the cover 402 may be exposed to the outside through the storage compartment, and the inner surface of the cover 401 may not be exposed to the outside.

The cover 400 may include the cover frame 410 and the light emitting plate 420. The light emitting plate 420 may be coupled to the cover frame 410. However, the light emitting plate 420 may also be formed integrally extending with the cover frame 410.

The cover frame 410 may prevent light emitted from a light source 310 of the lamp 300 from being transmitted directly to a front side of the storage compartment. This may prevent glare that may be caused by lighting within the storage compartment when the user opens the door.

The lamp 300 may be mounted on the cover frame 410. The cover frame 410 may prevent the lamp 300 from being exposed to the outside. The cover frame 410 may form an outer perimeter of the cover 400. The cover frame 410 may be formed to surround the light emitting plate 420. The cover frame 410 may be formed from an opaque material.

The light emitting plate 420 may be formed on an inner side of the cover frame 410. The light emitting plate 420 may direct the light emitted from the lamp 300 into the interior of the storage compartment.

The light emitting plate 420 may be formed from a material that is light transmissive. The light emitting plate 420 may also be formed of a translucent material. As a result, exposure of shadows formed by the wire disposed within the receiving space 210 of the lamp receiving portion 200 may be prevented. In addition, the brightness of the light emitted into the storage compartment may be adjusted. The light emitting plate 420 may have a microscopic surface treatment capable of diffusing light, and may be coated or painted to have a surface luminescence effect as needed.

The cover 400 may include a lamp mounting portion 430. The lamp 300 may be coupled to the lamp mounting portion 430 and mounted on the cover 400. By mounting the lamp 300 on the cover 400, the lighting assembly 100 may be easily assembled and repaired.

The lamp mounting portion 430 may be arranged on the cover inner surface 401. The lamp mounting portion 430 may be arranged on the cover frame 410 of the cover 400, so that the lamp 300 may be installed on the cover frame 410 of the cover 400. The lamp mounting portion 430 may include a mounting protrusion 431, a front support protrusion 435, and a side support protrusion 438. Further details thereof will be described later.

The cover 400 may include coupling protrusions 450a and 450b. The cover 400 may be coupled to the inner case 11 by coupling protrusions 450a and 450b. The coupling protrusions 450a and 450b may be arranged on the cover frame 410 of the cover 400. The coupling protrusions 450a and 450b may be provided on an inner surface of the cover frame 410 in a shape that protrudes upward. The coupling protrusions 450a and 450b may be provided in a plurality and may include a hook shape.

The cover 400 may include an anti-light leakage portion 411. The anti-light leakage portion 411 may be arranged on the cover inner surface. The anti-light leakage portion 411 may be arranged on the inner surface of the cover frame 410 of the cover 400. The anti-light leakage portion 411 may include ribs that protrude upwardly along the perimeter of the cover frame 410. When the cover 400 is coupled to the inner case 11, the anti-light leakage portion 411 may fill a gap between the cover 400 and the inner case 11 to prevent light from leaking through the gap.

Referring to FIG. 12, the lamp may be mounted on the lamp mounting portion of the cover.

The lamp 300 may include a substrate 320, the light source 310, and a wire connector 330. The light source 310 may emit light and may include an LED chip. The light source 310 may be mounted on the substrate 320 and arranged on one side of the substrate 320. The light sources 310 may be provided in a plurality. The light source 310 may emit light toward the reflective surface 203.

The wire connector 330 may be arranged on one side of the lamp 300. The wire connector 330 may be arranged on one surface of the substrate 320. The wire connector 330 may be arranged to connect the wire to the lamp 300 so that the lamp 300 may receive power.

The lamp 300 may be installed such that a light emitting surface of the light source 310 is disposed in a direction perpendicular to the cover 400. As a result, the light emitted from the light source 310 may be prevented from being directed directly to the cover 400, thereby preventing the area of the cover 400 corresponding to the light source 310 from becoming locally brighter. The light source 310 may be disposed in a direction facing the reflective surface 203 of the lamp receiving portion 200.

The lamp 300 may be coupled to the mounting protrusion 431. The substrate 320 of the lamp 300 may be coupled to the mounting protrusion 431. The mounting protrusion 431 may have a protrusion shape extending upwardly from the cover inner surface 401. The mounting protrusion 431 may be formed to protrude upwardly. The mounting protrusion 431 may include a hook shape. The mounting protrusions 431 may be provided in a plurality.

A mounting rib 432 may be disposed on a rear side of the mounting protrusion 431. The mounting rib 432 may be arranged to extend from the mounting protrusion 431. The mounting rib 432 may increase the rigidity of the mounting protrusion 431.

The lamp 300 may be supported by the support protrusions 435 and 438. The support protrusion may include the front support protrusion 435 and the side support protrusion 438.

The front support protrusion 435 may be spaced apart from the mounting protrusion 431 by a predetermined distance. The lamp 300 may be installed between the front support protrusion 435 and the mounting protrusion 431. One surface of the substrate 320 on which the light source 310 of the lamp 300 is provided may face the mounting protrusion 431, and the other surface opposite to the one surface may face the front support protrusion 435. The front support protrusion 435 may be disposed in front of the mounting protrusion 431.

The front support protrusion 435 may have a plate shape extending upwardly from the inner surface of the cover 400. The front support protrusion 435 may be formed to protrude upwardly. The front support protrusions 435 may be provided in a plurality.

A front support rib 436 may be provided in front of the front support protrusion 435. The front support rib 436 may be provided extending from the front support protrusion 435. The front support rib 436 may be formed by extending along a long side of the cover 400. The front support rib 436 may increase the rigidity of the front support protrusion 435.

The mounting protrusion 431 and the front support protrusion 435 may adjust the angle of the lamp 300 coupled to the cover 400. In particular, by installing the mounting protrusion 431 and the front support protrusion 435 at a predetermined angular inclination, the lamp 300 coupled to the mounting protrusion 431 and supported by the front support protrusion 435 may be implemented at a predetermined angular inclination.

The cover 400 may include a wire guide portion 439. The wire guide portion 439 may guide the wire connected from the wire connector 330 of the lamp 300 to the wire housing 500. In particular, the wire guide portion 439 may secure the wire to the inner surface 401 of the cover 400, thereby minimizing the length of the wire exposed to the cover 400. The wire guide portion 439 may be arranged to face an opposite side to a side of the substrate 320 on which the wire connector 330 is arranged. The wire guide portion 439 may be formed to protrude from the inner surface of the cover 400. The wire guide portion 439 may include a hook shape. The wire guide portion 439 may be provided on the cover frame 410 of the cover 400.

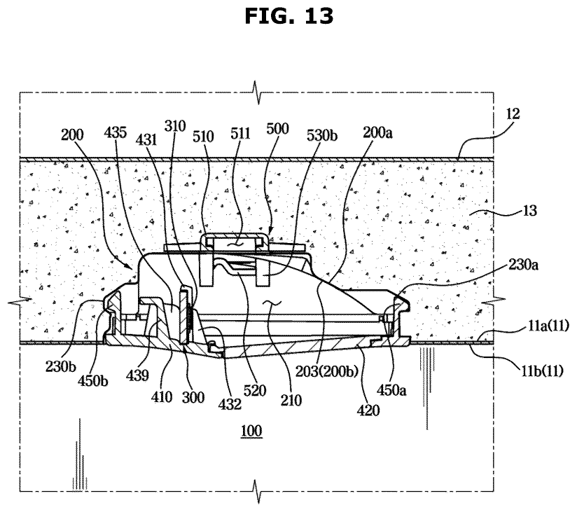

FIG. 13 is a cross-sectional view of the lighting assembly.

An embodiment according to the present disclosure discloses a lighting assembly in which a configuration of a lamp case may be omitted by forming the lamp receiving portion recessed in the inner case itself without having to provide a separate lamp case. In other words, by integrally implementing the shape of the lamp receiving portion in the inner case, the inner case itself may form the space for receiving the lamp and the reflective surface may be provided so that light emitted from the lamp may be reflected into the storage compartment.

By integrally forming the lamp receiving portion with the inner case, the manufacturing process may be simplified and the number of parts may be reduced. Furthermore, by incorporating the reflective surface into the lamp receiving portion, the manufacturing process may be simplified and the number of parts may be reduced.

In addition, the risk of molten resin for forming the insulation leaking through the gap between the conventional lamp case and the opening of the inner case may be reduced. In particular, compared to the conventional area of the opening of the inner case for coupling the lamp case, the present disclosure may have a smaller area of the opening of the inner case for coupling the wire housing, thereby reducing the probability of molten resin leakage.

The lamp receiving portion 200 may be disposed on an upper surface of the storage compartment 21, and the reflecting surface 203 may be disposed on a rear side of the lamp 300. The wire housing opening 220 may be disposed on an upper portion of the lamp receiving portion 200.

The coupling protrusions 450a and 450b of the cover 400 may be coupled correspondingly to the coupling grooves 230a and 230b of the lamp receiving portion 200. The lamp 300 may be supported by the cover 400 and installed in the receiving space 210 of the lamp receiving portion 200. The wire (not shown) connected to the lamp 300 may be led to the outside of the inner case 11 through the wire through hole 511 of the wire housing 500. The light emitted from the lamp 300 may be directed toward a rear side of the lamp receiving portion 200.

The reflective surface 203 may be located at a position facing the light source 310. The reflective surface 203 may reflect light emitted from the light source 310 toward the light emitting plate 420 of the cover 400.

The reflective surface 203 may include an inclined surface. The reflective surface 203 may have a curved surface that allows light emitted from the light source 310 to be reflected toward the cover 400. To this end, the reflective surface 203 may be formed to be inclined or rounded to move closer to the cover opening 211 of the lamp receiving portion 200 as it moves away from the location where the light source 310 is disposed. The reflective surface 203 may have a concave rounded shape from the inner surface of the lamp receiving portion 200 toward the rear side of the storage compartment. The reflective surface 203 may be arranged to be inclined downwardly toward the cover 400 coupled to the lamp receiving portion 200 as it moves away from the light source 310. The reflective surface 203 may be arranged to be inclined downwardly toward the upper surface of the storage compartment 21 as it approaches the rear side of the storage compartment 21.

The wire penetrating portion 510 of the wire housing 500 may be disposed in a direction corresponding to one side on which the wire connector 330 of the lamp 300 is arranged. In other words, the wire connected from the wire connector 330 of the lamp 300 may be led through the wire guide portion 439 and out of the wire through hole 511 of the wire penetrating portion 510 to the outside of the inner case 11, thereby minimizing the length of the exposed wire inside the lamp receiving portion 200.

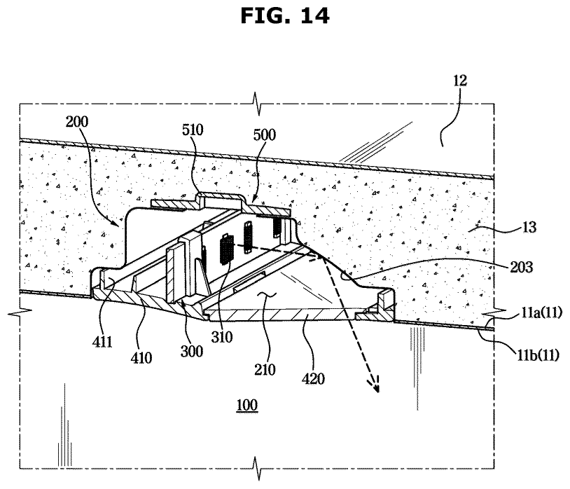

FIG. 14 is a view showing the lighting assembly when illuminated.

A portion of the light emitted from the light source 310 of the lamp 300 may be directed to the reflective surface 203, and the reflective surface 203 may reflect the light back to the light emitting plate 420 of the cover 400. Since the reflective surface 203 may be formed to be inclined or rounded with respect to the light source 310 and the cover 400, it may effectively reflect the light emitted from the light source 310 toward the light emitting plate 420 of the cover 400. Light passing through the light emitting plate 420 of the cover 400 may become light reflected from the reflective surface 203, and thus the lighting assembly 100 may be illuminated in the form of surface light.

Some of the light emitted from the light source 310 may be directed directly to the cover 400. Accordingly, by providing the opaque cover frame 410 on the cover 400, glare and light haze may be avoided.

Some of the light emitted from the light source 310 may also leak through the gap between the lamp receiving portion 200 and the cover 400. Accordingly, by providing the anti-light leakage portion 411 on the cover 400, light may be prevented from leaking out.

While the present disclosure has been particularly described with reference to exemplary embodiments, it should be understood by those of skilled in the art that various changes in form and details may be made without departing from the spirit and scope of the present disclosure.

What is claimed is:

1. A refrigerator comprising:
an inner case, forming a storage compartment, and including a lamp receiving portion having a receiving space that is recessed;
an outer case coupleable to an outer side of the inner case;
a lamp, arrangeable in the receiving space of the inner case, and including a light source that emits light; and
a cover coupleable to the inner case so as to cover the receiving space while the cover is coupled to the inner case;
wherein the lamp receiving portion includes a reflective surface at a position facing the light source to reflect light emitted from the light source of the lamp, which is arranged in the receiving space, toward the storage compartment.

2. The refrigerator of claim 1, wherein the reflective surface is configured to be inclined.

3. The refrigerator of claim 2, wherein the reflective surface is inclined downwardly toward the cover as a distance from the light source increases.

4. The refrigerator of claim 1, further comprising an insulation foamed between the outer case and the inner case,
wherein an outer surface of the lamp receiving portion facing the outer case is in contact with the insulation.

5. The refrigerator of claim 4, wherein an inner surface opposite to the outer surface of the lamp receiving portion forms the receiving space and includes the reflective surface.

6. The refrigerator of claim 1, wherein the lamp receiving portion includes an opening through which an electric wire that is connectable to the lamp is led to outside of the inner case so as to supply power to the lamp.

7. The refrigerator of claim 6, further comprising a wire housing, coupleable to the opening of the lamp receiving portion, and including a through hole through which the electric wire passes to allow the electric wire to be led to outside of the lamp receiving portion.

8. The refrigerator of claim 7, wherein the through hole of the wire housing is arrangeable along a direction corresponding to one side of the lamp connected to the electric wire.

9. The refrigerator of claim 7, wherein the cover includes a wire guide portion to guide the electric wire, which is connected to the lamp, to the through hole of the wire housing and protrude from a bottom to secure the electric wire.

10. The refrigerator of claim 1, wherein an inner surface of the lamp receiving portion facing the lamp includes a coupling groove to which the cover is coupled.

11. The refrigerator of claim 1, wherein the cover includes a lamp mounting portion protruding from a bottom to support the lamp.

12. The refrigerator of claim 11, wherein
the cover includes a cover frame forming a perimeter and a light emitting plate transmitting light emitted from the lamp into the storage compartment, and
the lamp mounting portion is arrangeable on the cover frame.

13. The refrigerator of claim 12, wherein the reflective surface is configured to be inclined with the light emitting plate so as to reflect light emitted from the light source to the light emitting plate of the cover.

14. The refrigerator of claim 13, wherein the light emitting plate is formed of a translucent material.

15. A refrigerator comprising:
an outer case forming an exterior thereof;
an inner case arrangeable within the outer case to form a storage compartment, the inner case including a lamp receiving portion formed to be recessed to accommodate a lamp; and
an insulation arrangeable between the outer case and the inner case;
wherein an inner surface of the lamp receiving portion facing the lamp includes a reflective surface configured to reflect light emitted from the lamp, which is arranged in the lamp receiving portion, toward the storage compartment, and
an outer surface of the lamp receiving portion is in contact with the insulation.
